(19) United States
(12) Patent Application Publication
(10) Pub. No.: US 2006/0067174 A1
(43) Pub. Date: Mar. 30, 2006

(54) Optical disk drive for compensating wobble signal and method thereof

(75) Inventors: Jen-Yu Hsu, Taipei (TW); Hsiang-Yi Fu, Taipei (TW); Tun-Chieh Lee, Taipei (TW); Fu-Hsiang Chen, Taipei (TW)

Correspondence Address: BIRCH STEWART KOLASCH & BIRCH, PO BOX 747, FALLS CHURCH, VA, 22040-0747, US

(73) Assignee: Lite-On it Corporation

(21) Appl. No.: 11/230,724

(22) Filed: Sep. 21, 2005

(30) Foreign Application Priority Data
Sep. 22, 2004 (TW) 93128774

(51) Int. Cl. G11B 7/00

(52) U.S. Cl. 369/44.13; 369/44.28; 369/47.36

(57) ABSTRACT

An optical disk drive for compensating wobble signal and the method thereof. The compensating method is used in an optical pick-up head and a servo controller. The optical pick-up head includes a laser diode and a photo detectors. Firstly, the laser diode emits a beam focused on an optical disc to generate a reflective beam. Next, the photo detector receives the reflective beam to generate plural photo detecting signals. A servo controller receives the photo detecting signals to generate a processed signal. The objective lens is moved according to the processed signal. The photo detector receives the reflective beam to generate the photo detecting signals until the absolute value of the processed signal is not larger than a fixed value, then the photo detector receives the reflective beam to generate plural calibrated photo detecting signals. Lastly, a wobble signal is generated according to the calibrated photo detecting signals.

This application claims the benefit of Taiwan application Serial No. 93128774, filed Sep. 22, 2004, the subject matter of which is incorporated herein by reference.

### BACKGROUND OF THE INVENTION

1. Field of the Invention

The invention relates in general to a method for compensating a wobble signal, and more particularly to an optical disc drive for compensating a wobble signal and the method thereof.

2. Description of the Related Art

The optical disc has a spiral track disposed thereon. The optical pick-up head emits a laser beam to the above track then receives the reflected laser beam reflected from the tracks to access data. Generally speaking, the spiral track disposed on the optical disc has smooth edges. Currently, optical discs with special specifications such CD-R, DVD-R or DVD-RW have wave-like marks disposed on the track edges. The marks are called wobble addressing marks, and the signal read from the marks are called the wobble signal. The wobble signal define the corresponding address of the data stored in the optical disc. Therefore, the stability of wobble signal is crucial to record the data. If the wobble signal is not stable or of poor quality, the corresponding address of the data cannot be correctly defined, easily resulting in recording failure of the optical disc.

### SUMMARY OF THE INVENTION

It is therefore the object of the invention to provide an optical disk drive for compensating wobble signal and the method thereof. A processed signal is generated according to the wobble addressing marks disposed on the optical disc, then the wobble signal are compensated according to the processed signal. Consequently, the quality of the signals is stabilized, and the error rate in recording is reduced and the success rate in recording is increased.

According to an object of the invention, an optical disc drive is provided. The optical disc drive includes a servo controller and an optical pick-up head. The servo controller is electrically coupled with the optical pick-up head. The optical pick-up head includes a laser diode, an objective lens and a photo detector. The laser diode is for emitting a beam. The objective lens is for focusing the beam on an optical disc. The photo detector is for receiving a reflective beam the optical disc to generate and output a number of photo detecting signals accordingly. The servo controller, after receiving the photo detecting signals, generates a processed signal accordingly. The objective lens is moved according to the processed signal when the absolute value of the processed signal is larger than a fixed value. The step of receiving the reflective beam by the photo detector to generate the photo detecting signals is repeated until the absolute value of the processed signal is not larger than a fixed value. The photo detector then receives the reflective beam again to accordingly output a number of calibrated photo detecting signals. The servo controller generates a wobble signal according to the calibrated photo detecting signals.

According to another object of the invention, a method for compensating wobble signals used in an optical pick-up head is provided. The optical pick-up head includes a laser diode, a photo detector and an objective lens. The compensating method includes the following steps. Firstly, the laser diode emits a beam focused on optical disc via an objective lens to generate a reflective beam. Next, the photo detector receives the reflective beam to generate a number of photo detecting signals. Then, a servo controller receives the photo detecting signals to generate a processed signal. The objective lens is moved according to the processed signal when the absolute value of the processed signal is larger than a fixed value. The step of receiving the reflective beam by the photo detector to generate the photo detecting signals is repeated until the absolute value of the processed signal is not larger than a fixed value. Then, the photo detector receives the reflective beam again to generate a number of calibrated photo detecting signals. Lastly, a wobble signal is generated according to the calibrated photo detecting signals.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a structure diagram of an optical disc drive;

FIGS. 2A, 2B and 2C are images of the structure and reflective beam of a photo detector;

FIG. 3 is a flowchart of a compensating method according to a preferred embodiment of the invention.

### DETAILED DESCRIPTION OF THE INVENTION

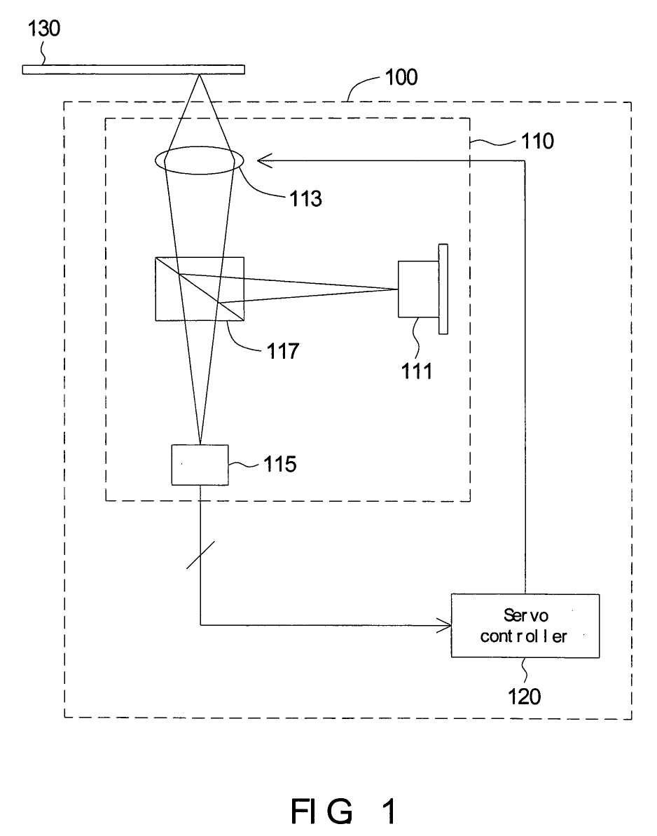

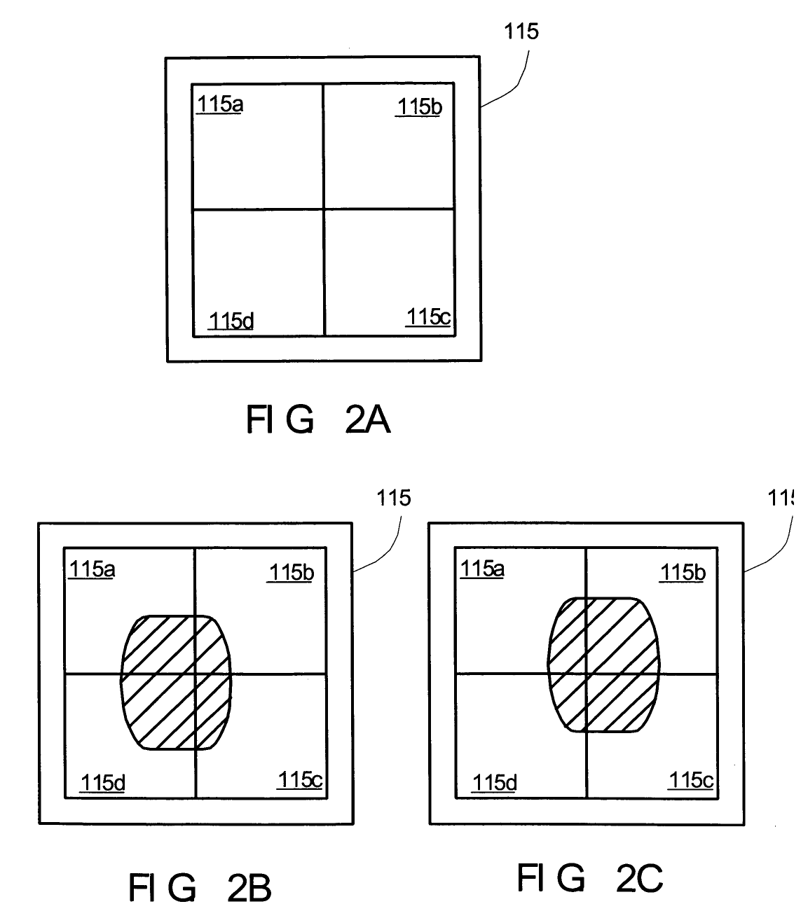

Referring to FIG. 1, a structure diagram of an optical disc drive according to a preferred embodiment of the invention is shown. An optical disc drive 100 includes an optical pick-up head 110 and a servo controller 120. The optical pick-up head 110 is electrically coupled with the servo controller 120. The optical pick-up head 110 includes a laser diode 111, an objective lens 113, a photo detector 115 and a beam splitter 117. The laser diode 111 is for emitting a beam focused on the optical disc 130 via the beam splitter 117 and objective lens 113. The photo detector 115 receives a reflective beam reflected by the optical disc 130 according to the received beam intensity and outputting accordingly a number of photo detecting signals. Generally speaking, the photo detector 115 has at least 4 photo detection units disposed thereon with each photo detection unit respectively receiving a reflective beam and outputting an photo detecting signal as shown in FIG. 2A. In the photo detector 115, a photo detection unit 115a generates a first photo detecting signal (A), a photo detection unit 115b generates a second photo detecting signal (B), a photo detection unit 115c is for generating a third photo detecting signal (C), and a photo detection unit 115d generates a fourth photo detecting signal (D).

Therefore, the invention is used when the absolute value of the processed signal is larger than a fixed value. The servo controller 120 moves the objective lens 113 according to the processed signal. For example, the objective lens 113 is traversed, so that the photo detector 115 continues to receive the reflective beam to generate the four photo detecting signals until the absolute value of the processed signal is not larger than the fixed value. Meanwhile, the photo detector 115 receives the reflective beam and accordingly output a number of calibrated photo detecting signals, so that the servo controller 120 generates the processed signal according to the calibrated detecting signals. If a higher standard of precision is requested of the wobble signal, the fixed value can be set to 0.

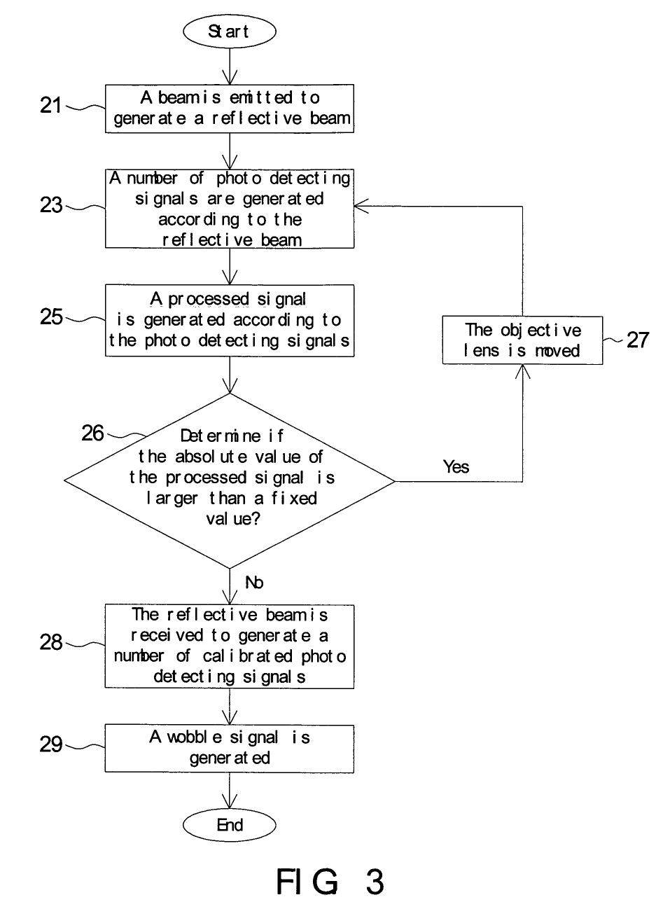

Referring to FIG. 3, a flowchart of a compensating method according to a preferred embodiment of the invention is shown. The compensating method is used in an optical pick-up head including a laser diode, an objective lens and a photo detector. Firstly, a beam is emitted by the laser diode, and a reflective beam is generated after the beam is focused on an optical disc via an objective lens as shown in step 21. Next, the reflective beam is received by the photo detector to generate a number of photo detecting signals as shown in step 23. Then, the photo detecting signals are received by a servo controller for further processing and a processed signal is generated as shown in step 25.

Meanwhile, whether the absolute value of the processed signal is larger than a fixed value or not is determined in step 26. If the absolute value of the processed signal is larger than a fixed value, the objective lens is moved according to the processed signal as shown in step 27. The steps 23, 25 and 26 are repeated until the absolute value of the processed signal is smaller than the fixed value. If the absolute value of the processed signal is smaller than or equal to fixed value, thus generated photo detecting signal are called calibrated photo detecting signals. It means the reflective beam is received by respective photo detection units for generating calibrated photo detecting signals as shown in step 28. Lastly, the wobble signal is generated according to the calibrated photo detecting signals as shown in step 29. If a higher precision standard is requested of the wobble signal, the fixed value can be set to 0.

The step 23 of generating a number of photo detecting signals according to the present embodiment further includes a first photo detecting signal (A), a second photo detecting signal (B), a third photo detecting signal (C) and a fourth photo detecting signal (D). In the step 25, the processed signal is defined as (A+D)-(B+C). In the step 27, the objective lens is traversed according to the processed signal having larger absolute value.

The optical disc drive for compensating wobble signal and the method thereof disclosed in above embodiment of the invention compensate wobble signal according to the relationship formula of the photo detecting signals, so that the corresponding address of the data can be affirmed and that recording failure due to incorrect correspondence of data address can be reduced. Moreover, the compensating method is cost-benefit effective for not any extra devices or circuits are required.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for compensating wobble signals used for accessing an optical pick-up head of an optical disc, wherein the optical pick-up head comprises a laser diode, a photo detector and an objective lens, the compensating method comprises:
emitting a beam by the laser diode, wherein the beam is focused on the optical disc via the objective lens to generate a reflective beam;
receiving the reflective beam by the photo detector to generate a plurality of photo detecting signals;
using a servo controller to receive the photo detecting signals to generate a processed signal according to the photo detecting signals;
when the absolute value of the third control signal is larger than a fixed value, the objective lens is moved according to the processed signal, and the above step of generating a plurality of photo-detecting signal to generate a processed signal is repeated until the absolute value of the processed signal is not larger than the fixed value, then the photo detector receives the reflective beam again to generate a plurality of calibrated photo-detecting signals; and
generating a wobble signal according to the calibrated photo detecting signals.

2. The method according to claim 1, wherein the optical disc has a spiral track, the beam is focused on the track of the optical disc to generate the reflective beam via the objective lens, the track has a plurality of wobble addressing marks.

3. The method according to claim 1, wherein the photo detecting signals comprises a first photo detecting signal (A), a second photo detecting signal (B), a third photo detecting signal (C) and a fourth photo detecting signal (D).

4. The method according to claim 3, wherein in the step of generating the processed signal, the processed signal is defined as (A+D)-(B+C).

5. The method according to claim 1, wherein when the absolute value of the processed signal is larger than a fixed value, the objective lens is traversed according to the processed signal.

6. An optical disc drive used for accessing an optical disc, wherein the optical disc drive comprises:
a servo controller; and
an optical pick-up head electrically coupled with the servo controller, wherein the optical pick-up head comprises:
a laser diode for emitting a beam;
an objective lens for focusing the beam on the optical disc; and
a photo detector for receiving a reflective beam generated by the optical disc drive according to the beam and outputting a plurality of photo detecting signals accordingly;
wherein, after receiving the photo detecting signals, the servo controller generates a processed signal accordingly, moves the objective lens according to the processed signal when the absolute value of the processed signal is larger than a fixed value, and enables the photo detector to receive the reflective beam to generate the photo detecting signals until the absolute value of the processed signal is not larger than the fixed value; wherein when the absolute value of the processed signal is not larger than the fixed value, the photo detector receives the reflective beam and outputs a plurality of calibrated electrical signals accordingly, and the servo controller generates a wobble signal according to the calibrated electrical signals.

7. The optical disc drive according to claim 6, wherein the optical disc has a spiral track, the beam is focused on the track of the optical disc via the objective lens to generate the reflective beam, the track has a plurality of wobble addressing marks.

8. The optical disc drive according to claim 6, wherein the photo detecting signals comprises a first photo detecting signal (A), a second photo detecting signal (B), a third photo detecting signal (C) and a fourth photo detecting signal (D).

9. The optical disc drive according to claim 8, wherein the processed signal is defined as (A+D)-(B+C).

10. The optical drive according to claim 6, the objective lens traverses according to the processed signal.
